(19) United States
(12) Patent Application Publication
(10) Pub. No.: US 2020/0044454 A1
(43) Pub. Date: Feb. 6, 2020

(54) Maximum Power Point Tracking Method and Device for Photovoltaic Cell and Storage Medium

(71) Applicant: Dongtai Hi-Tech Equipment Technology Co.,Ltd, Beijing (CN)

(72) Inventor: Haixia SU, Beijing (CN)

(21) Appl. No.: 16/202,119

(22) Filed: Nov. 28, 2018

(30) Foreign Application Priority Data
Aug. 3, 2018 (CN) 201810879460.4

(51) Int. Cl. H02J 3/38; G05B 19/406

(52) U.S. Cl. CPC H02J 3/385; G05B 2219/2639; G05B 19/406

(57) ABSTRACT

A Maximum Power Point Tracking method and device for a photovoltaic cell and a storage medium are provided by the present disclosure. The MPPT method for the photovoltaic cell includes that: multiple power points corresponding to different duty ratios of an MPPT controller respectively are acquired and a first duty ratio corresponding to the power point with a maximum value is determined from the multiple power points; a first maximum power point of the photovoltaic cell is tracked in a single-peak manner by using the first duty ratio as an initial value, and the first maximum power point is set as a maximum power value of the photovoltaic cell; and after the first maximum power point is tracked, it is determined to continue tracking a second maximum power point in the single-peak manner according to a predetermined condition, or, operations are re-executed from the first step.

### TECHNICAL FIELD

The present disclosure relates to the field of photovoltaic cells, and in particular to a Maximum Power Point Tracking (MPPT) method and device for a photovoltaic cell and a storage medium.

### BACKGROUND

A photovoltaic cell is sustainable clean energy capable of converting optical energy into electrical energy by use of a photovoltaic effect of a semiconductor. An output power of the photovoltaic cell changes along with an output voltage. During a practical application, an MPPT controller is usually adopted to track a maximum power point of the photovoltaic cell to acquire maximum power of the photovoltaic cell. A method for tracking the maximum power point is an MPPT control method. Common MPPT control methods include a constant voltage method, a perturbation and observation method and an incremental conductance method. These methods are applied to a uniform illuminance condition for the photovoltaic cell. A power curve of the photovoltaic cell under the uniform Illuminance condition has only one peak. However, since the photovoltaic cell is partially blocked due to factors of clouds, buildings and the like, there may usually exist a condition that the power curve has multiple peaks. Since single-peak search is involved in the common methods, the maximum power point cannot be determined to cause energy loss when the photovoltaic cell works at a local optimum point under a multi-peak condition.

Aiming at a technical problem of incapability in accurately tracking a changing maximum power point of the photovoltaic cell in the related art, an effective solution has not been presented.

### SUMMARY

At least some embodiments of the present disclosure provide an MPPT method and device for a photovoltaic cell and a storage medium, so as at least to partially solve a technical problem of incapability in accurately tracking a changing maximum power point of the photovoltaic cell in the related art.

In an embodiment of the present disclosure, an MPPT method for a photovoltaic cell is provided, which includes: a first step: acquiring a plurality of power points corresponding to different duty ratios of an MPPT controller respectively and determining a first duty ratio corresponding to a power point with a maximum value from the plurality of power points; a second step: tracking a first maximum power point of the photovoltaic cell in a single-peak manner by using the first duty ratio as an initial value, and the first maximum power point is set as a maximum power value of the photovoltaic cell; and a third step: after the first maximum power point is tracked, determining to continue tracking a second maximum power point in the single-peak manner according to a predetermined condition, or, re-executing operations from the first step, and the predetermined condition includes at least one of a time period and a power change amplitude.

In an optional embodiment, the power change amplitude includes a predetermined range determined according to the first maximum power point, the predetermined range is a continuous numerical range including the first maximum power point, and the third step includes: determining the predetermined range according to the first maximum power point, and the predetermined range is the continuous numerical range including the first maximum power point; determining whether the second maximum power point falls within the predetermined range or not; and under the condition that the second maximum power point does not fall within the predetermined range, re-executing the operations from the first step.

In an optional embodiment, the third step further includes: under the condition that the second maximum power point falls within the predetermined range, determining whether a predetermined duration has passed after the first maximum power point is obtained or not; and after the predetermined duration has passed, re-executing the operations from the first step.

In an optional embodiment, the predetermined duration takes a hour as a unit.

In an optional embodiment, the predetermined range is from the first maximum power point*(1−a first percentage) to the first maximum power point*(1+a second percentage), and the first percentage is the same as the second percentage or the first percentage is different from the second percentage.

In an optional embodiment, the third step further includes: determining whether a predetermined duration has passed after the first maximum power point is obtained or not; and after the predetermined duration has passed, re-executing the operations from the first step.

In an optional embodiment, the third step further includes: progressively increasing each of different duty ratios by a predetermined step length from an initial value of each duty ratio to obtain increased duty ratios, and acquiring power points respectively corresponding to the increased duty ratios, and the initial value and the predetermined step length are preconfigured.

In another embodiment of the present disclosure, an MPPT device for a photovoltaic cell is also provided, which includes: an acquisition element, configured to acquire a plurality of power points corresponding to different duty ratios of an MPPT controller respectively and determine a first duty ratio corresponding to a power point with a maximum value from the a plurality of power points; a tracking element, configured to track a first maximum power point of the photovoltaic cell in a single-peak manner by using the first duty ratio as an initial value, and the first maximum power point is set as a maximum power value of the photovoltaic cell; and a determination element, configured to, after the first maximum power point is tracked, determine to continue tracking a second maximum power point in the single-peak manner according to a predetermined condition, or, re-execute the operations from the acquisition element, and the predetermined condition includes at least one of a time period and a power change amplitude.

In an optional embodiment, the power change amplitude includes a predetermined range determined according to the first maximum power point, the predetermined range is a continuous numerical range including the first maximum power point, and the determination element includes: a first determination component, configured to determine the predetermined range according to the first maximum power point, and the predetermined range is a continuous numerical value including the first maximum power point; a second determination component, configured to determine whether the second maximum power point falls within the predetermined range or not; and a third determination component, configured to, under the condition that the second maximum power point does not fall within the predetermined range, re-execute the operations from the acquisition element.

In an optional embodiment, the determination element further includes: a fourth determination component, configured to, under the condition that the second maximum power point falls within the predetermined range, determine whether a predetermined duration has passed after the first maximum power point is obtained or not; and a fifth determination component, configured to, after the predetermined duration has passed, re-execute the operations from the acquisition element.

In an optional embodiment, the predetermined duration takes a hour as a unit.

In an optional embodiment, the predetermined range is from the first maximum power point*(1−a first percentage) to the first maximum power point*(1+a second percentage), and the first percentage is the same as the second percentage or the first percentage is different from the second percentage.

In an optional embodiment, the determination element further includes: a sixth determination component, configured to determine whether a predetermined duration has passed after the first maximum power point is obtained or not; and a seventh determination component, configured to, after the predetermined duration has passed, re-execute the operations from the acquisition element.

In an optional embodiment, the acquisition element includes: an acquisition component, configured to progressively increase each of different duty ratios by a predetermined step length from an initial value of each duty ratio to obtain increased duty ratios, and acquire power points respectively corresponding to the increased duty ratios, and the initial value and the predetermined step length are preconfigured.

In another embodiment of the present disclosure, a storage medium is also provided, which includes a stored program, the stored program running to execute any abovementioned MPPT method for the photovoltaic cell.

In another embodiment of the present disclosure, a processor is also provided, which is configured to run a program, the program running to execute any abovementioned MPPT method for the photovoltaic cell.

In at least some embodiments of the present disclosure, the multiple power points corresponding to different duty ratios of the MPPT controller respectively are acquired and the first duty ratio corresponding to the power point with the maximum value is determined from the multiple power points; the first maximum power point of the photovoltaic cell is tracked in the single-peak manner by using the first duty ratio as the initial value, the first maximum power point being set as the maximum power value of the photovoltaic cell; and after the first maximum power point is tracked, it is determined to continue tracking the second maximum power point in the single-peak manner according to the predetermined condition, or, the operations are re-executed from the first step, the predetermined condition including at least one of the time and the power change amplitude. A purpose of continuously tracking the maximum power point of the photovoltaic cell is achieved, a technical effect of accurately determining the maximum power point of the photovoltaic cell in a tracking process is achieved and the technical problem of incapability in accurately tracking the changing maximum power point of the photovoltaic cell in the related art is further solved.

### BRIEF DESCRIPTION OF THE DRAWINGS

The accompanying drawings described here are used for providing a deeper understanding of the present disclosure, and constitute a part of the application. Schematic embodiments of the present disclosure and description thereof are used for illustrating the present disclosure and not intended to form an improper limit to the present disclosure. In the accompanying drawings:

FIG. 1 is a schematic diagram of a hardware environment of an MPPT method for a photovoltaic cell according to an embodiment of the present disclosure.

FIG. 2 is a flowchart of an MPPT method for a photovoltaic cell according to an embodiment of the present disclosure.

FIG. 3 is a schematic diagram of a photovoltaic control system according to an exemplary embodiment of the present disclosure.

FIG. 4 is a flowchart of an MPPT control method according to an exemplary embodiment of the present disclosure.

FIG. 5 is a schematic diagram of an MPPT device for a photovoltaic cell according to an embodiment of the present disclosure.

### DETAILED DESCRIPTION

In order to make those skilled in the art understand the solutions of the present disclosure better, technical solutions in embodiments of the present disclosure are clearly and completely elaborated below in combination with the accompanying drawings. It is apparent that the described embodiments are only a part of the embodiments of the present disclosure but not all. Based on the embodiments of the present disclosure, all the other embodiments obtained by those of ordinary skill in the art on the premise of not contributing creative effort should belong to the protection scope of the present disclosure.

It is to be noted that the terms like “first” and “second” in the specification, the claims and the accompanying drawings of the present disclosure are used for differentiating the similar objects, but do not have to describe a specific order or a sequence. It should be understood that the objects may be exchanged under appropriate circumstances, so that the embodiments of the present disclosure described here may be implemented in an order different from that described or shown here. Moreover, the terms like “include” and “have” and any variation of them are intended to cover nonexclusive including; for example, the process, method, system, product or device including a series of steps or elements do not have to be limited to those clearly listed steps or elements, but may include other steps or elements which are not clearly listed or inherent in these process, method, system, product or device.

In an embodiment of the present disclosure, an MPPT method for a photovoltaic cell is provided. It is to be noted that these steps presented in the flowchart of the accompanying drawings can be executed in a computer system like a group of computer executable instructions, and moreover, although a logical sequence is shown in the flowchart, in some cases, the presented or described steps can be performed in a sequence different from that described here.

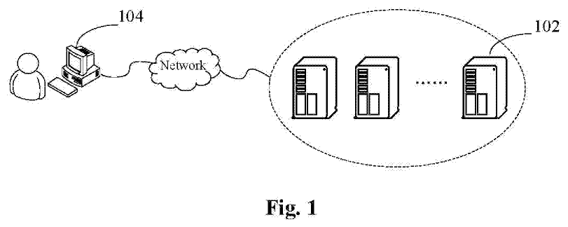

Optionally, in this embodiment, the MPPT method for the photovoltaic cell may be applied to a hardware environment formed by a server 102 and a terminal 104 as shown in FIG. 1. According to the embodiment as shown in FIG. 1, the server 102 is connected with the terminal 104 through a network. The network includes, but not limited to: a wide area network, a metropolitan area network or a local area network. The terminal 104 is not limited to a Personal Computer (PC), a mobile phone, a tablet computer and the like. The MPPT method of this embodiment for the photovoltaic cell may be executed by the server 102, may also be executed by the terminal 104 and may also be executed by both of the server 102 and the terminal 104. When being executed by the terminal 104, the MPPT method of this embodiment for the photovoltaic cell may also be executed by a client installed in the terminal 104.

Optionally, a process that the server 102 executes the MPPT method of this embodiment for the photovoltaic cell may be described as follows. The server 102 acquires multiple power points corresponding to different duty ratios of an MPPT controller respectively and determines a first duty ratio corresponding to a power point with a maximum value in the multiple power points. The server 102 tracks a first maximum power point of the photovoltaic cell in a single-peak manner by using the first duty ratio as an initial value, the first maximum power point being set as a maximum power value of the photovoltaic cell. And the server 102, after the first maximum power point is tracked, determines to continue tracking a second maximum power point in the single-peak manner according to a predetermined condition, or, re-executes the operations mentioned above, the predetermined condition including at least one of a time period and a power change amplitude.

Optionally, a process that the terminal 104 or the client executes the MPPT method of this embodiment for the photovoltaic cell may be described as follows. The terminal 104 or the client acquires multiple power points corresponding to different duty ratios of an MPPT controller respectively and determines a first duty ratio corresponding to a power point with a maximum value in the multiple power points. The terminal 104 or the client tracks a first maximum power point of the photovoltaic cell in a single-peak manner by using the first duty ratio as an initial value, the first maximum power point being set as a maximum power value of the photovoltaic cell. And the terminal 104 or the client, after the first maximum power point is tracked, determines to continue tracking a second maximum power point in the single-peak manner according to a predetermined condition, or, re-executes the operations mentioned above, the predetermined condition including at least one of a time period and a power change amplitude.

Optionally, a process that the server 102 and one of the terminal 104 and the client execute the MPPT method of this embodiment for the photovoltaic cell together may be described as follows. The terminal 104 or the client acquires multiple power points corresponding to different duty ratios of an MPPT controller respectively and determines a first duty ratio corresponding to a power point with a maximum value in the multiple power points. The terminal 104 or the client tracks a first maximum power point of the photovoltaic cell in a single-peak manner by using the first duty ratio as an initial value, the first maximum power point being set as a maximum power value of the photovoltaic cell. And the server 102, after the first maximum power point is tracked, determines to continue tracking a second maximum power point in the single-peak manner according to a predetermined condition, or, re-executes the operations mentioned above, the predetermined condition including at least one of a time period and a power change amplitude, and sends the second maximum power point to the terminal 104 or the client.

The MPPT method of this embodiment for the photovoltaic cell will be described below in detail with the condition that the client is an executed object.

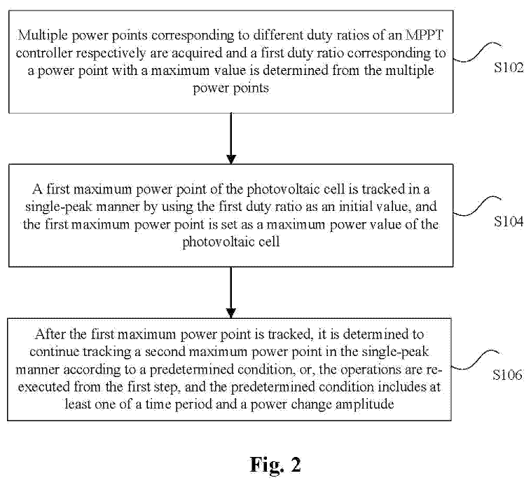

FIG. 2 is a flowchart of an MPPT method for a photovoltaic cell according to an embodiment of the present disclosure. As shown in FIG. 2, the method includes the following steps.

At step S102, multiple power points corresponding to different duty ratios of an MPPT controller respectively are acquired and a first duty ratio corresponding to a power point with a maximum value is determined from the multiple power points.

At step S104, a first maximum power point of the photovoltaic cell is tracked in a single-peak manner by using the first duty ratio as an initial value, and the first maximum power point is set as a maximum power value of the photovoltaic cell.

At step S106, after the first maximum power point is tracked, it is determined to continue tracking a second maximum power point in the single-peak manner according to a predetermined condition, or, the operations are re-executed from the first step, and the predetermined condition includes at least one of a time period and a power change amplitude.

It is to be noted that the steps are defined for a better expression cycle, such a sequence of the steps is not specifically limited to be unique and steps in another sequence may be adopted to execute the method.

The power change amplitude may include a predetermined range determined according to the first maximum power point and the predetermined range is a continuous numerical value including the first maximum power point.

By the steps that the multiple power points corresponding to different duty ratios of the MPPT controller respectively are acquired and the first duty ratio corresponding to the power point with the maximum value is determined from the multiple power points; the first maximum power point of the photovoltaic cell is tracked in the single-peak manner by using the first duty ratio as the initial value, the first maximum power point being set as the maximum power value of the photovoltaic cell; and after the first maximum power point is tracked, it is determined to continue tracking the second maximum power point in the single-peak manner according to the predetermined condition, or, the operations are re-executed from the step S102, and the predetermined condition includes at least one of the time and the power change amplitude, no open-circuit voltage or saturation current is required to be set as a parameter, and a load and a storage battery are not required to be switched off, so that energy loss is reduced and MPPT accuracy of the photovoltaic cell is improved.

In an optional embodiment of a solution provided at step S102, the duty ratios may be divided according to a practical requirement. For example, a range of a duty ratio of a Pulse Width Modulation (PWM) wave is 0%˜100%. An initial value of the duty ratio is set to be 10%, so that 10% is set as a step length for changing the duty ratio, the duty ratio is progressively increased from 10% to 100%. That is, there are totally 10 different duty ratios 10%, 20% . . . 100% for output of the PWM wave, and the number of acquired points is 10. Output power, corresponding to the 10 duty ratios, of the photovoltaic cell is recorded and a duty ratio corresponding to a maximum power value is recorded as Dmax. There is a one-to-one correspondence between the duty ratios of the PWM wave and the output power of the photovoltaic cell, and thus the power value corresponding to the duty ratio Dmax is a region where a maximum power point is located. A magnitude of a value of each power point is compared to further determine the first duty ratio corresponding to the maximum power point.

In an optional embodiment of a solution provided at step S104, a first maximum power value of the photovoltaic cell may be tracked in the single-peak manner by using the first duty ratio as the initial value. For example, the maximum power value of the photovoltaic cell may be tracked through a perturbation and observation method or an incremental conductance method, so as to obtain the maximum power value of the photovoltaic cell.

In an optional embodiment of a solution provided at step S106, after the first maximum power point is tracked and when an illumination condition changes, the maximum power value of the photovoltaic cell may also be tracked and determined according to the time and a difference between the second maximum power point and the first maximum power point.

Optionally, the third step may include that: the predetermined range is determined according to the first maximum power point, the predetermined range being a continuous numerical range including the first maximum power point; whether the second maximum power point falls within the predetermined range or not is determined; and under the condition that the second maximum power point does not fall within the predetermined range, the operations are re-executed from the step S102.

For example, in the embodiment, the predetermined range may be determined according to the first maximum power point, the subsequently tracked second maximum power point is compared with the predetermined range, and under the condition that the second maximum power point does not fall within the predetermined range, the second maximum power point may be determined as the maximum power value of the photovoltaic cell.

Optionally, the operation that it is determined whether to determine the second maximum power point as the maximum power value of the photovoltaic cell or not includes that: under the condition that the second maximum power point falls within the predetermined range, whether a predetermined duration has passed after the first maximum power point is obtained or not is determined; and after the predetermined duration has passed, the operations are re-executed from the step S102.

Optionally, the predetermined duration takes a hour as the unit.

Optionally, the predetermined range is from the first maximum power point*(1−a first percentage) to the first maximum power point*(1+a second percentage), and the first percentage is the same as the second percentage or the first percentage is different from the second percentage.

Optionally, the third step further includes that: whether a predetermined duration has passed after the first maximum power point is obtained or not is determined; and after the predetermined duration has passed, the operations are re-executed from the step S102.

Optionally, the operation that the multiple power points corresponding to different duty ratios of the MPPT controller respectively are acquired may include that: each of different duty ratios is progressively increased by a predetermined step length from an initial value of each duty ratio to obtain increased duty ratios, and power points respectively corresponding to the increased duty ratios are acquired, and the initial value and the predetermined step length are preconfigured.

The present disclosure also provides an exemplary embodiment. The exemplary embodiment provides an MPPT control method capable of preventing local optimum.

FIG. 3 is a schematic diagram of a photovoltaic control system according to an exemplary embodiment of the present disclosure. As shown in FIG. 3, the photovoltaic control system includes a photovoltaic cell, an MPPT controller, a Direct Current-Direct Current (DC-DC), a storage battery and a load. This is a common photovoltaic control system. The photovoltaic cell charges the storage battery through the MPPT controller and the DC-DC and may also supply power to the load. The MPPT controller changes a duty ratio of a PWM wave to change an equivalent load of the photovoltaic cell, thereby changing an output power of the photovoltaic cell.

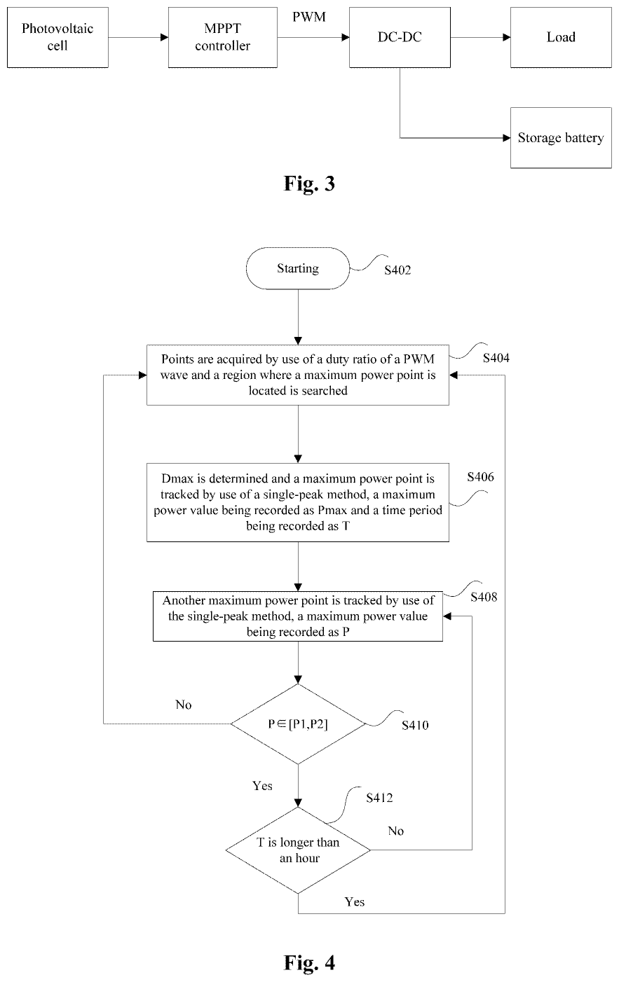

FIG. 4 is a flowchart of an MPPT control method according to an exemplary embodiment of the present disclosure. As shown in FIG. 4, the method includes the following steps.

At step S402, the method is started.

At step S404, points are acquired by use of the duty ratio of the PWM wave and a region where a maximum power point is located is searched.

At step S406, the maximum power point is tracked by a single-peak method, a maximum power value being recorded as Pmax and a time period being record as T.

At step S408, another maximum power point is tracked by the single-peak method, a maximum power value being recorded as P.

At step S410, whether P belongs to P∈[P1, P2] or not is determined.

At step S412, whether T is longer than an hour or not is determined.

Specific steps of the MPPT control method of the exemplary embodiment may be described as follows.

AT Step 1, the MPPT controller acquires points by use of the duty ratio of the PWM wave to determine the region where the maximum power point is located. A range of the duty ratio of the PWM wave is 0%˜100%. An initial value of the duty ratio is set to be 10%, and 10% is set as a step length for changing the duty ratio. The duty ratio is progressively increased from 10% to 100%. That is, there are totally 10 different duty ratios 10%, 20% . . . 100% for output of the PWM wave, and the number of the acquired points is 10. An output power, corresponding to the 10 duty ratios, of the photovoltaic cell is recorded and the duty ratio corresponding to the maximum power value is recorded as Dmax. There is one-to-one correspondence between the duty ratios of the PWM wave and the output power of the photovoltaic cell, and thus the power value corresponding to the duty ratio Dmax is the region where the maximum power point is located.

At Step 2, the maximum power point of the photovoltaic cell is tracked by the single-peak method (such as a perturbation and observation method or an incremental conductance method). The region where the maximum power point of the photovoltaic cell is located has been determined at Step 1, and thus the maximum power point of the photovoltaic cell may be searched in this region by use of the single-peak tracking method instead. The single-peak method used in the present disclosure is the perturbation and observation method or the incremental conductance method. The initial value of the duty ratio of the PWM wave is Dmax obtained at Step 1. Since perturbation and observation method and the incremental conductance method are both common MPPT control methods, a specific implementation method will not be elaborated herein.

After the maximum power point is determined by use of the single-peak method, the controller is required to execute the following operations.

At one, starting timing and a time period is recorded as T.

At two, the tracked maximum power value is recorded as Pmax and a limit value for power change is calculated, which including:

recording a power value 20% higher than the maximum power value as P1, that is, P1=Pmax*1.2, and recording a power value 20% lower than the maximum power value as P2, that is, P2=Pmax*0.8.

At Step 3, the maximum power point is tracked and recorded. After the maximum power point is tracked at Step 2, another maximum power point is continued to be tracked by use of the single-peak method and a maximum power value tracked after the maximum power value Pmax is recorded as P. Since illuminance for the photovoltaic cell is changeable, that is, the illuminance may change, but change degrees are different. The single-peak method (such as the perturbation and observation method or the incremental conductance method) keeps working to track the maximum power point, and thus the tracked maximum power point also changes. The tracked maximum power value is recorded as P.

At Step 4, whether the MPPT method is required to be changed or not is determined by use of the power value. When the illuminance for the photovoltaic cell changes greatly, that is, an illumination intensity changes greatly or in case of partial blocking, power of the photovoltaic cell may change greatly and continuing tracking the maximum power point by use of the single-peak method in such case may cause a local optimum state. Therefore, the MPPT method is required to be changed.

It is to be noted that, when the maximum power value P at Step 3 is in a range of [P1, P2], that is, P∈[P1, P2], it is considered that the illuminance for the photovoltaic cell does not change greatly and Step 5 is executed. Otherwise it is considered that an illumination environment changes greatly and Step 1 is executed to restart searching the maximum power point.

At Step 5, whether the MPPT method is required to be changed or not is determined by use of the time period. If the time period T is longer than an hour, although the output power of the photovoltaic cell is P∈[P1, P2], the illumination environment of the photovoltaic cell has actually changed greatly after an hour, and for preventing a local optimum state of the maximum power point of the photovoltaic cell, Step 1 is executed to restart searching the maximum power point. Otherwise Step 3 is executed to continue tracking the maximum power point by use of the single-peak method.

In a working process executed by use of the single-peak method, a control system determines whether the illuminance for the photovoltaic cell changes greatly or not according to Step 4 and Step 5, namely making a comprehensive determination according to the power change and the tracking time period, and determines whether the MPPT method is required to be changed or not according to a determination result, thereby effectively preventing occurrence of the problem of local optimum of the maximum power point of the photovoltaic cell.

The exemplary embodiment has the following key innovations.

The MPPT control method includes the following specific implementation steps.

At Step 1, points are acquired by use of the duty ratio of the PWM wave and the region where the maximum power point is located is searched.

At Step 2, the maximum power point is tracked by use of the single-peak method (such as the perturbation and observation method or the incremental conductance method). The initial value of the duty ratio of the PWM wave is Dmax obtained at Step 1. After the maximum power point is determined, timing is started, the time period being T. The maximum power value is recorded as Pmax.

At Step 3, another maximum power point is continued to be tracked by use of the single-peak method and the maximum power value tracked after the maximum power value Pmax is recorded as P.

At Step 4, when P∈[P1, P2], Step 5 is executed, otherwise Step 1 is executed to restart searching the maximum power point.

At Step 5, if T is longer than an hour, Step 1 is executed, otherwise Step 3 is executed.

A point acquisition method for searching the region where the maximum power point is located is as follows. The initial value of the duty ratio of the PWM wave is set to be 10%, 10% is set as a step length for changing the duty ratio, and the duty ratio is progressively increased from 10% to 100%. That is, there are totally 10 different duty ratios 10%, 20% . . . 100% for output of the PWM wave. The 10 points cover the whole interval of the PWM wave. Therefore, corresponding output voltages cover the whole output voltage interval of the photovoltaic cell.

The number of the duty ratios of the PWM wave may be changed according to a running speed of the controller. If the running speed is higher, more points may be acquired and the determined region where the maximum power point is located is more accurate. Therefore, the number of the acquired points may be selected according to an actual running speed of the controller but should at least not be smaller than 10.

Whether the MPPT method is required to be changed or not is determined in the process of working by use of the single-peak method and the following two determination conditions about the power and the tacking time period are comprehensively utilized:

the maximum output power P of the photovoltaic cell exceeds the range [P1, P2], that is, P∈[P1, P2] is not met; and

the output power P does not exceed the range [P1, P2], that is, P∈[P1, P2], but the time period T reaches an hour.

If any abovementioned condition is met, the MPPT method is changed and Step 1 is re-executed to search another maximum power point.

A calculation method for the power limit value used for the operation that whether to change the MPPT method or not is determined is:

P1=Pmax*1.2, and

P2=Pmax*0.8,

and Pmax is a first maximum power value tracked by use of the single-peak method in implementation Step 2.

By the steps, the exemplary embodiment has the following beneficial technical effects.

At one, when the region where the maximum power point is located is searched, the points are acquired by use of the duty ratio of the PWM wave. Not only is it ensured that the number of the acquired points is definite, and the point acquisition method is simple and easy. But also it is ensured that the point acquisition range covers the whole output voltage interval of the photovoltaic cell, so that the region where the maximum power point may be rapidly determined.

At two, when the maximum power point is tracked by use of the single-peak method, whether the tracking method is required to be changed or not is comprehensively determined by use of a maximum power change value and the tracking time period, so that local optimum of the maximum power value is avoided.

According to the method, no sensor is required to acquire temperature and illumination intensity variables, so that hardware cost is reduced.

At three, according to the MPPT control method in the present disclosure, no open-circuit voltage or saturation current is required to be set as a parameter and then the load and the storage battery are not required to be switched off in the MPPT process, so that energy loss is reduced.

In another embodiment of the present disclosure, an MPPT device for a photovoltaic cell is also provided. It is to be noted that the MPPT device for the photovoltaic cell may be configured to execute the MPPT method for the photovoltaic cell in the embodiments of the present disclosure. That is, the MPPT method for the photovoltaic cell in the embodiments of the present disclosure may be executed in the MPPT device for the photovoltaic cell.

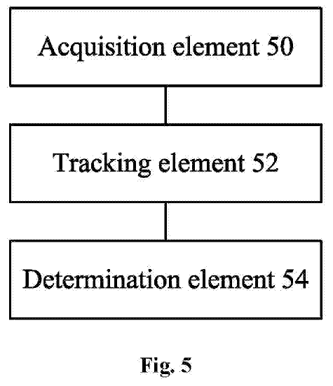

FIG. 5 is a schematic diagram of an MPPT device for a photovoltaic cell according to an embodiment of the present disclosure. As shown in FIG. 5, the device may include: an acquisition element 50, configured to acquire multiple power points corresponding to different duty ratios of an MPPT controller respectively and determine a first duty ratio corresponding to a power point with a maximum value from the multiple power points; a tracking element 52, configured to track a first maximum power point of the photovoltaic cell in a single-peak manner by using the first duty ratio as an initial value, and the first maximum power point is set as a maximum power value of the photovoltaic cell; and a determination element 54, configured to, after the first maximum power point is tracked, determine to continue tracking a second maximum power point in the single-peak manner according to a predetermined condition, or, re-execute the operations from the acquisition element, and the predetermined condition including at least one of a time period and a power change amplitude.

The power change amplitude may include a predetermined range determined according to the first maximum power point and the predetermined range is a continuous numerical value including the first maximum power point.

By the steps that the acquisition element 50 may be configured to acquire the multiple power points corresponding to different duty ratios of the MPPT controller respectively and determine the first duty ratio corresponding to the power point with the maximum value in the multiple power points; the tracking element 52 may be configured to track the first maximum power point of the photovoltaic cell in the single-peak manner by using the first duty ratio as the initial value, and the first maximum power point is set as the maximum power value of the photovoltaic cell; and the determination element 54 may be configured to, after the first maximum power point is tracked, determine to continue tracking the second maximum power point in the single-peak manner according to the predetermined condition, or, re-execute the operations from the acquisition element, the predetermined condition including at least one of the time period and the power change amplitude, no open-circuit voltage or saturation current is required to be used as a parameter and a load and a storage battery are not required to be switched off, so that energy loss is reduced and MPPT accuracy of the photovoltaic cell is improved.

It is to be noted that the acquisition element 50 in the embodiment may be configured to execute step S102 in the embodiments of the present disclosure, the tracking element 52 in the embodiment may be configured to execute step S104 In the embodiments of the present disclosure and the determination element 54 in the embodiment may be configured to execute step S106 in the embodiments of the present disclosure. The components implement an example and application scenario the same as those implemented by the corresponding steps but are not limited to the contents disclosed in the abovementioned embodiment.

Optionally, the determination element 54 includes: a first determination component, configured to determine a predetermined range according to the first maximum power point, and the predetermined range is a continuous numerical range including the first maximum power point; a second determination component, configured to determine whether the second maximum power point falls within the predetermined range or not; and a third determination component, configured to, under the condition that the second maximum power point does not fall within the predetermined range, re-execute the operations from the acquisition element.

Optionally, the determination element 54 includes: a fourth determination component, configured to, under the condition that the second maximum power point falls within the predetermined range, determine whether a predetermined duration has passed after the first maximum power point is obtained or not; and a fifth determination component, configured to, after the predetermined duration has passed, re-execute the operations from the acquisition element.

Optionally, the predetermined duration takes a hour as a unit.

Optionally, the predetermined range is from the first maximum power point*(1−a first percentage) to the first maximum power point*(1+a second percentage), and the first percentage is the same as the second percentage or the first percentage is different from the second percentage.

Optionally, the determination element 54 includes: a sixth determination element, configured to, determine whether a predetermined duration has passed after the first maximum power point is obtained or not; and a seventh determination element, configured to, after the predetermined duration has passed, re-execute the operations from the acquisition element.

Optionally, the acquisition element 50 includes: an acquisition component, configured to progressively increase each of different duty ratios by a predetermined step length from an initial value of each duty ratio to obtain increased duty ratios, and acquire power points respectively corresponding to the increased duty ratios, wherein the initial value and the predetermined step length are preconfigured.

In order to achieve the purpose, the embodiments of the present disclosure also provide a storage medium, which includes a stored program, the stored program running to control equipment where the storage medium is located to execute the abovementioned MPPT method for the photovoltaic cell.

In order to achieve the purpose, the embodiments of the present disclosure also provide a processor, which is configured to run a program, the program running to execute the abovementioned MPPT method for the photovoltaic cell.

The above sequence numbers of the embodiments of the present disclosure are just for describing, instead of representing superiority-inferiority of the embodiments.

In the above embodiments of the present disclosure, the descriptions of the embodiments focus on different aspects. The part which is not described in a certain embodiment in detail may refer to the related description of the other embodiments.

In some embodiments provided by the application, it should be understood that the disclosed technical contents may be implemented in other manners. Herein, the embodiment of the device described above is only schematic. For example, division of the elements is only division of logical functions, and other division manners may be adopted during practical implementation. For example, multiple elements or components may be combined or integrated to another system, or some features may be ignored or are not executed. In addition, shown or discussed coupling, direct coupling or communication connection may be implemented through indirect coupling or communication connection of some interfaces, elements or components, and may be in an electrical form or other forms.

The elements described as separate parts may or may not be separate physically, and parts displayed as elements may or may not be physical elements, that is, they may be located in the same place, or may also be distributed to a plurality of elements. Part or all of the elements may be selected to achieve the purpose of the solutions of the embodiments according to a practical requirement.

In addition, each functional element in each embodiment of the present disclosure may be integrated into a processing element, each element may also physically exist independently, and two or more than two elements may also be integrated into an element. The integrated element may be implemented in a hardware form and may also be implemented in form of software functional element.

If being implemented in form of software functional element and sold or used as an independent product, the integrated element may be stored in a computer-readable storage medium. Based on such an understanding, the technical solutions of the present disclosure substantially or parts making contributions to the conventional art or all or part of the technical solutions may be embodied in form of software product. The computer software product is stored in a storage medium, including a plurality of instructions configured to enable a computer device (which may be a PC, a server, a network device or the like) to execute all or part of the steps of the method in each embodiment of the present disclosure. The storage medium includes various media capable of storing program codes such as a U disk, a Read-Only Memory (ROM), a Random Access Memory (RAM), a mobile hard disk, a magnetic disk or an optical disk.

The above are the exemplary embodiments of the present disclosure. It is to be pointed out that those of ordinary skill in the art may also make a number of improvements and embellishments without departing from the principle of the present disclosure and these improvements and embellishments should also fall within the scope of protection of the present disclosure.

What is claimed is:

1. A Maximum Power Point Tracking (MPPT) method for a photovoltaic cell, comprising:
a first step: acquiring a plurality of power points corresponding to different duty ratios of an MPPT controller respectively and determining a first duty ratio corresponding to a power point with a maximum value from the plurality of power points;
a second step: tracking a first maximum power point of the photovoltaic cell in a single-peak manner by using the first duty ratio as an initial value, wherein the first maximum power point is set as a maximum power value of the photovoltaic cell; and
a third step: after the first maximum power point is tracked, determining to continue tracking a second maximum power point in the single-peak manner according to a predetermined condition, or, re-executing operations from the first step, wherein the predetermined condition comprises at least one of a time period and a power change amplitude.

2. The method as claimed in claim 1, wherein the power change amplitude comprises a predetermined range determined according to the first maximum power point, the predetermined range is a continuous numerical range comprising the first maximum power point, and the third step comprises:
determining whether the second maximum power point falls within the predetermined range or not; and
under the condition that the second maximum power point does not fall within the predetermined range, re-executing the operations from the first step.

3. The method as claimed in claim 2, wherein the third step further comprises:
under the condition that the second maximum power point falls within the predetermined range, determining whether a predetermined duration has passed after the first maximum power point is obtained or not; and
after the predetermined duration has passed, re-executing the operations from the first step.

4. The method as claimed in claim 2, wherein the predetermined duration takes a hour as a unit.

5. The method as claimed in claim 2, wherein the predetermined range is from the first maximum power point*(1−a first percentage) to the first maximum power point*(1+a second percentage), wherein the first percentage is the same as the second percentage or the first percentage is different from the second percentage.

6. The method as claimed in claim 1, wherein the third step further comprises:
determining whether a predetermined duration has passed after the first maximum power point is obtained or not; and
after the predetermined duration has passed, re-executing the operations from the first step.

7. The method as claimed in claim 1, wherein the third step further comprises:
progressively increasing each of different duty ratios by a predetermined step length from an initial value of each duty ratio to obtain increased duty ratios, and acquiring power points respectively corresponding to the increased duty ratios, wherein the initial value and the predetermined step length are preconfigured.

8. A Maximum Power Point Tracking (MPPT) device for a photovoltaic cell, comprising:
an acquisition element, configured to acquire a plurality of power points corresponding to different duty ratios of an MPPT controller respectively and determine a first duty ratio corresponding to a power point with a maximum value from the a plurality of power points;
a tracking element, configured to track a first maximum power point of the photovoltaic cell in a single-peak manner by using the first duty ratio as an initial value, wherein the first maximum power point is set as a maximum power value of the photovoltaic cell; and
a determination element, configured to, after the first maximum power point is tracked, determine to continue tracking a second maximum power point in the single-peak manner according to a predetermined condition, or, re-execute the operations from the acquisition element, wherein the predetermined condition comprises at least one of a time period and a power change amplitude.

9. The device as claimed in claim 8, wherein the power change amplitude comprises a predetermined range determined according to the first maximum power point, the predetermined range is a continuous numerical range comprising the first maximum power point, and the determination element comprises:
a first determination component, configured to determine the predetermined range according to the first maximum power point, wherein the predetermined range is a continuous numerical value comprising the first maximum power point;
a second determination component, configured to determine whether the second maximum power point falls within the predetermined range or not; and
a third determination component, configured to, under the condition that the second maximum power point does not fall within the predetermined range, re-execute the operations from the acquisition element.

10. The device as claimed in claim 9, wherein the determination element further comprises:
a fourth determination component, configured to, under the condition that the second maximum power point falls within the predetermined range, determine whether a predetermined duration has passed after the first maximum power point is obtained or not; and
a fifth determination component, configured to, after the predetermined duration has passed, re-execute the operations from the acquisition element.

11. The device as claimed in claim 9, wherein the predetermined duration takes a hour as a unit.

12. The device as claimed in claim 8, wherein the predetermined range is from the first maximum power point*(1−a first percentage) to the first maximum power point*(1+a second percentage), wherein the first percentage is the same as the second percentage or the first percentage is different from the second percentage.

13. The device as claimed in claim 8, wherein the determination element further comprises:
a sixth determination component, configured to determine whether a predetermined duration has passed after the first maximum power point is obtained or not; and
a seventh determination component, configured to, after the predetermined duration has passed, re-execute the operations from the acquisition element.

14. The device as claimed in claim 8, wherein the acquisition element comprises:
an acquisition component, configured to progressively increase each of different duty ratios by a predetermined step length from an initial value of each duty ratio to obtain increased duty ratios, and acquire power points respectively corresponding to the increased duty ratios, wherein the initial value and the predetermined step length are preconfigured.

15. A storage medium, comprising a stored program, the stored program running to control equipment where the storage medium is located to execute the method as claimed in claim 1.

16. A processor, configured to run a program, the program running to execute the method as claimed in claim 1.
